(19) United States
(12) Patent Application Publication
(10) Pub. No.: US 2026/0327069 A1
(43) Pub. Date: Oct. 22, 2026

(54) PROCESS FOR PERFORMING AN ENDOTHERMIC REACTION IN A REACTOR WITH LESS CO2-EMISSIONS

(71) Applicant: BASF SE, Ludwigshafen am Rhein (DE)

(72) Inventors: Elias Christopher FREI, Ludwigshafen am Rhein (DE); Andrea HAUNERT, Ludwigshafen am Rhein (DE); Maximilian VICARI, Ludwigshafen am Rhein (DE); Lukasz KARWACKI, Ludwigshafen am Rhein (DE); Xavier SAVA, Ludwigshafen am Rhein (DE); Nils BOTTKE, Ludwigshafen am Rhein (DE)

(21) Appl. No.: 19/111,335

(22) PCT Filed: Sep. 15, 2023
(86) PCT No.: PCT/EP2023/075402

§ 371 Date: Mar. 13, 2025

(30) Foreign Application Priority Data
Sep. 16, 2022 (EP) 22196173.3

(51) Int. Cl. C01B 3/047

(52) U.S. Cl. CPC C01B 3/047; C01B 2203/0244; C01B 2203/0811; C01B 2203/1064; C01B 2203/1205

(57) ABSTRACT

The present invention relates to a process for performing an endothermic reaction in a reactor, the process particularly comprising heating a combustible stream comprising NH₃ to a temperature in the range of from 25 to 850 °C, wherein heating comprises transferring heat of a reaction from a chemical conversion process to the combustible stream; feeding the heated combustible gas stream into a combustion chamber, wherein a portion of a reactor passes through the combustion chamber; combusting the combustible gas stream with oxygen in the combustion chamber, for heating the portion of the reactor passing through the combustion chamber to a temperature in the range of from 500 to 2100 °C; feeding a feedstock gas stream comprising one or more reactants into the heated reactor for performing the endothermic reaction; and reacting the feedstock gas stream in the heated reactor.

### TECHNICAL FIELD

The present invention relates to a process for performing an endothermic reaction in a reactor, the process particularly comprising a step of heating a combustible stream comprising NH₃, optionally reforming NH₃ for obtaining a gas stream comprising N₂ and H₂, combusting the heated combustible gas stream or the gas stream comprising N₂ and H₂ with oxygen in a combustion chamber, for heating a portion of the reactor passing through the combustion chamber, and reacting a feedstock gas stream in the heated reactor for obtaining a product gas stream, wherein heating comprises transferring heat of a reaction from a chemical conversion process to the combustible stream.

### INTRODUCTION

NH₃ can be seen as an energy vector of the future, since it is able to chemically store significant amounts of H₂. For including the hydrogen back into a chemical process or another application the NH₃ can be reformed to nitrogen and hydrogen (see equation 1). Further, NH₃ might also be used as sustainable carbon-free fuel in fired heaters. Generally, NH₃ can be used directly or reformed, wherein the reforming can be performed partially or completely. The degree of NH₃ reforming basically depends on the needs of the coupled fuel application, wherein a higher hydrogen content is typically used for increasing the flame temperature. In addition thereto, NH₃ can be used as co-fuel as it is or after being reformed. For example, a conventional natural gas-based fired heater can be co-fueled with NH₃ as it is or after being reformed. This enables at least partial decarbonization of the fired heaters, dependent on the amount of substituted natural gas by NH₃-containing fuel. Since the NH₃ reforming step is an endothermic reaction (+45.6 KJ/mol), additional energy has to be invested. Also the evaporation of the normally liquid NH₃ to gaseous one is an energy intense step (+23 KJ/mol).

NH₃⇄0.5N₂+1.5H₂ (+45.6 kJ/mol) (1)

WO 2019/038251 A1 relates to an autothermal ammonia cracking process, in particular to a process for the production of a product gas containing nitrogen and hydrogen from ammonia comprising the steps of non-catalytic partial oxidation of ammonia with an oxygen containing gas to a process gas containing nitrogen, water, amounts of nitrogen oxides and residual amounts of ammonia; cracking of at least a part of the residual amounts of ammonia to hydrogen and nitrogen in the process gas by contact with a nickel containing catalyst and simultaneously reducing the amounts of nitrogen oxides to nitrogen and water by reaction with a part of the hydrogen formed during cracking of the process gas by contact of the process gas with the nickel containing catalyst; and withdrawing the hydrogen and nitrogen containing product gas.

Banares-Alcantara et al. disclose in Applied Energy 2021, 282, 116009 a forecast of ammonia as energy carrier, in particular its role in combined cycle gas turbines for power generation.

U.S. Pat. No 8,464,515 B2 discloses an NH₃ burning internal combustion engine in which a reformed gas reformed at a reformer is fed in a combustion chamber.

U.S. Pat. Nos. 8,691,182 B2 and 8,961,923 B2 relate to methods of cracking ammonia particularly comprising heating a gas stream comprising ammonia and a gas stream comprising oxygen in a heat-exchanger, reacting said gas streams in a mixing burner, for obtaining a hydrogen-containing gas mixture, cooling the obtained hydrogen-containing gas mixture in the heat exchanger.

Thus, there was a need to provide an improved process for performing an endothermic reaction wherein the process is conducted in a comparatively resource-efficient, in particular more sustainable, manner.

### DETAILED DESCRIPTION

It was therefore an object of the present invention to provide a novel process for performing an endothermic reaction, wherein in particular CO₂ emissions are reduced. It can be assumed that substituting 1 kg natural gas (LHV_{NG}=47 MJ/kg) by, e.g., 2.52 kg NH₃ (same energy content) saves directly 2.5-2.7 kg CO₂ emissions. This is a significant reduction of the CO₂ emissions of energy intense endothermic high temperature applications.

Surprisingly, it has been found that coupling a step of heating a combustible gas stream comprising NH₃ by heat transfer from a chemical conversion process leads to an improved process for performing an endothermic reaction. Said improvement is coupled to the reduction of CO₂ emission by substituting carbon-based energy carriers by NH₃.

The heat transfer can be realized for example by a heat exchanger. The needed energy for heat transfer can be provided by an exothermic reaction or excess heat of the heat employed for a high temperature endothermic reaction. In both cases the heat can be transferred via hot outlet gases or fluids.

The hot NH₃ can also be converted before combustion thereof, for example in an adiabatic reactor, also in the presence of a catalyst. The degree of conversion of NH₃ depends on the temperature thereof. Since the low heat value (LHV) of H₂ (LHV_{H2}=120 MJ/kg) is much higher compared to NH₃ (LHV_{NH3}=18.6 MJ/kg), the degree of NH₃ conversion or H₂ concentration is coupled to the temperature of the flame, when the fuel is fired. For example, a high temperature can be realized with a higher hydrogen concentration (or NH₃ conversion).

Thus, it has surprisingly been found that NH₃ either being converted or unconverted can function as a sustainable, carbon-free fuel. Further, it was found that it can especially be applied as co-fuel with natural gas. Also, it was found that the NH₃-containing stream can be heated by the excess heat of a chemical process. The degree of NH₃ reforming and H₂ concentration determines the flame temperature and its application.

The unit bar(abs) refers to an absolute pressure wherein 1 bar equals 10⁵ Pa.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.

Therefore, the present invention relates to a process for performing an endothermic reaction in
a reactor, the process comprising
   (i) providing a combustible stream comprising NH₃, wherein the stream is liquid or gaseous;
   (ii) heating the combustible stream provided in (i) to a temperature in the range of from 25 to 850 °C, for obtaining a heated combustible gas stream;
   (iii) optionally feeding the heated combustible gas stream obtained in (ii) into an ammonia reforming reactor for obtaining a gas stream comprising N₂ and H₂;
   (iv) feeding the heated combustible gas stream obtained in (ii) or the gas stream obtained in (iii) into a combustion chamber, wherein a reactor is contained in the combustion chamber;
   (v) combusting the combustible gas stream obtained in (ii) or the gas stream obtained in (iii) with oxygen in the combustion chamber, for heating the reactor contained in the combustion chamber to a temperature in the range of from 500 to 2100 °C, and for obtaining an exhaust gas stream exiting the combustion chamber;
   (vi) preparing a feedstock gas stream comprising one or more reactants for an endothermic reaction;
   (vii) feeding the feedstock gas stream into the heated reactor for performing the endothermic reaction;
   (viii) reacting the feedstock gas stream in the heated reactor for obtaining a product gas stream;
   wherein heating in (ii) comprises transferring heat of a reaction from a chemical conversion process to the combustible stream provided in (i), and
   wherein the exhaust gas stream obtained in (v) contains 5 volume-% or less of H₂.

Within the meaning of the present invention, the temperature of the reactor preferably designates the temperature of the reactor wall.

Furthermore, within the meaning of the present invention, the term “endothermic reaction” principally designates any chemical conversion process and/or any physicochemical process which requires an energy input in the form of heat, and is therefore endothermic. With regard to the physicochemical processes which fall under the term “endothermic reaction” within the meaning of the present invention, these can range anywhere from the heating of a process stream for affording a heated process stream, to the at least partial conversion of an element or chemical compound from one aggregate state to another such as the production of steam from a process stream comprising water. In particular, within the meaning of the present invention, the term “endothermic reaction” is not limited to chemical conversion processes. According to the present invention, it is however preferred that the term “endothermic reaction” is to be understood within the common meaning of the term as designating chemical conversion processes.

It is preferred that the combustible stream according to (i) has a temperature in the range of from 5 to 150 °C, more preferably in the range of from 15 to 120 °C, more preferably in the range of from 20 to 105 °C, more preferably in the range of from 40 to 80 °C, more preferably in the range of from 50 to 70 °C.

It is preferred that the combustible stream according to (i) has a pressure in the range of from 0.5 to 110 bar(abs), more preferably in the range of from 1 to 100 bar(abs), more preferably in the range of from 30 to 70 bar(abs), more preferably in the range of from 40 to 60 bar(abs).

It is preferred that the combustible stream according to (i) comprises from 0 to 1 volume-% of O₂, more preferably from 0 to 0.1 volume-%, more preferably from 0 to 0.01 volume-% of O₂.

It is preferred that the combustible stream according to (i) comprises from 98 to 100 volume-% of NH₃, more preferably from 99 to 100 volume-%, more preferably from 99.9 to 100 volume-% of NH₃.

It is preferred that the combustible stream according to (i) comprises from 0 to 2.0 volume-% of H₂O, more preferably from 0.01 to 1.5 volume-%, more preferably from 0.1 to 1.0 volume-% of H₂O.

It is preferred that from 90 to 100 volume-%, more preferably from 95 to 100 volume-%, more preferably from 99 to 100 volume-%, of the combustible stream according to (i) consist of NH₃ and H₂O.

It is preferred that the combustible stream is heated according to (ii) to a temperature in the range of from 50 to 850 °C, more preferably in the range of from 200 to 700 °C, more preferably in the range of from 300 to 600 °C, more preferably in the range of from 400 to 500 °C.

It is preferred that heating according to (ii) comprises transferring heat using a heat exchanger.

It is preferred that the heat which is transferred according to (ii) is provided by the exhaust gas stream exiting the combustion chamber according to (v) and/or from the product gas stream according to (viii).

It is preferred that the heat which is transferred according to (ii) is obtained from an exothermic reaction or wherein the heat which is transferred according to (ii) is excess heat of the heat employed for performing an autothermal reaction or an endothermic reaction.

In case where the heat which is transferred according to (ii) is obtained from an exothermic reaction, it is preferred that the exothermic reaction comprises, more preferably consists of, one or more of methanol production, dimethyl ether production, NH₃ production, ethylene epoxidation, sulfuric acid production, and selective oxidation of one or more of alkanes, alkenes and alkynes, preferably selective oxidation of one or more of alkanes, alkenes and alkynes to acrolein or acrylic acid.

In case where the heat which is transferred according to (ii) is excess heat of the heat employed for performing or an endothermic reaction, it is preferred that the endothermic reaction comprises, more preferably consists of, one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.

In case where the heat which is transferred according to (ii) is excess heat of the heat employed for performing an autothermal reaction, it is preferred that the autothermal reaction comprises, more preferably consists of, one or more of autothermal reforming of natural gas and hydrocarbons, and partial oxidation (POx) of hydrocarbons, wherein the hydrocarbons are selected from the group consisting of (C₁-C₁₀)alkanes, more preferably (C₁-C₈)alkanes, more preferably (C₁-C₇)alkanes.

It is preferred that in (iii) at least a portion of the NH₃ comprised in the heated combustible gas stream is converted in the ammonia reforming reactor to N₂ and H₂, wherein more preferably from 0.1 to 99.9 volume-%, more preferably from 5 to 95 volume-% of NH₃ comprised in the heated combustible gas stream is converted in the ammonia reforming reactor to N₂ and H₂, based on 100 volume-% of NH₃ comprised in the heated combustible gas stream.

It is preferred that the ammonia reforming reactor according to (iii) comprises a catalytic material, preferably the catalytic material as defined in any one of the particular and preferred embodiments of the present invention.

It is preferred that the reactor according to (iii) is an adiabatic reactor, an isothermal reactor, or a combination thereof.

Within the meaning of the present invention, an adiabatic or isothermal reactor is to be understood as a reactor working close to the theoretical adiabatic or isothermal process.

It is preferred that the heated combustible gas stream fed into the reactor according to (iii) has a gas hourly space velocity in the range of from 50 to 30,000/h, more preferably in the range of from 150 to 25,000/h, more preferably in the range of from 200 to 20,000/h, more preferably in the range of from 4,000 to 16,000/h, more preferably in the range of from 8,000 to 12,000/h.

It is preferred that the heated combustible gas stream fed into the reactor according to (iii) has a temperature in the range of from 100 to 1000 °C, more preferably in the range of from 200 to 900 °C, more preferably in the range of from 400 to 700 °C, more preferably in the range of from 500 to 600 °C.

It is preferred that the heated combustible gas stream fed into the reactor according to (iii) has a pressure in the range of from 1 to 100 bar(abs), more preferably in the range of from 10 to 35 bar(abs), more preferably in the range of from 14 to 31 bar(abs), more preferably in the range of from 18 to 27 bar(abs).

It is preferred that one or more co-fuels are fed into the combustion chamber together with the heated combustible gas stream obtained in (ii) or the gas stream obtained in (iii), wherein the one or more co-fuels are more preferably selected from the group consisting of naphtha, hydrogen, gasoline, crude oil, pyrolysis oil, gasification products of biomass, (bio-)ethanol, alkanes, and mixtures of two or more thereof, wherein the one or more co-fuels more preferably comprise, more preferably consist of, (C₁-C₄)alkanes and mixtures thereof, more preferably (C₁-C₃)alkanes and mixtures thereof, more preferably (C₁-C₂)alkanes and mixtures thereof, wherein more preferably the one or more co-fuels more preferably comprise, more preferably consist of, CH₄.

It is preferred that the reactor comprises, more preferably consists of, a reaction chamber or a tubular reactor, wherein the reactor preferably comprises, more preferably consists of, a tubular reactor, wherein the tubular reactor preferably comprises, more preferably consists of, 1 to 15,000 tubes, more preferably 100 to 11,000 tubes, and more preferably 500 to 5,000 tubes.

In case where the reactor comprises a tubular reactor, it is preferred that independently from one another, the one or more tubes of the tubular reactor have a length in the range of from 1 to 30 m, more preferably in the range of from 9 to 21 m, and more preferably in the range of from 13 to 17 m.

In case where the reactor comprises a tubular reactor, it is preferred that independently from one another, from 1 to 100 %, more preferably from 30 to 70 %, more preferably from 40 to 60 %, of the length of the tubes of the tubular reactor passes through the combustion chamber.

In case where the reactor comprises a tubular reactor, it is preferred that independently from one another, the tubes of the tubular reactor have a diameter in the range of from 0.01 to 10 m, more preferably in the range of from 2 to 8 m, and more preferably in the range of from 4 to 6 m.

It is preferred that combusting the combustible gas stream according to (v) comprises
(v.1) mixing the combustible gas stream with oxygen;
(v.2) combusting the mixture obtained in (v.1) in the combustion chamber, for obtaining a gas stream having a temperature in the range of from 500 to 2100 °C.

In case where combusting the combustible gas stream according to (v) comprises (v.1) mixing the combustible gas stream with oxygen, it is preferred that the volume ratio of oxygen to NH₃ comprised in the mixture obtained in (v.1) is in the range of from 1:10 to 9:1, more preferably in the range of from 1:5 to 1.8:1, and more preferably in the range of from 1:2 to 1.0:1.

It is preferred that the exhaust gas stream obtained in (v) contains from 0 to 4 volume-% of H₂, more preferably from 0 to 3 volume-%, more preferably from 0 to 2 volume-%, more preferably from 0 to 1 volume-%, more preferably from 0 to 0.1 volume-%, more preferably from 0 to 0.01 volume-% of H₂.

It is preferred that the exhaust gas stream obtained in (v) has a temperature in the range of from 850 to 2100 °C, more preferably in the range of from 950 to 1700 °C, more preferably in the range of from 1000 to 1400 °C.

It is preferred that the one or more reactants comprised in the feedstock gas stream according to (vi) are selected from the group consisting of naphtha, hydrogen, oxygen, gasoline, crude oil, pyrolysis oil, gasification products of biomass, (bio-)ethanol, methane, ethane, propane, butane, H₂O, CO₂, CO, NH₃, ethylbenzene, methanol, dimethyl ether, and mixtures of two or more thereof.

It is preferred that the feedstock gas stream fed into the heated reactor according to (vii) has a gas hourly space velocity in the range of from 50 to 300,000/h, more preferably in the range of from 150 to 250,000/h, more preferably in the range of from 200 to 200,000/h, more preferably in the range of from 500 to 100,000/h, more preferably in the range of from 2,000 to 50,000/h.

It is preferred that the feedstock gas stream fed into the heated reactor according to (vii) has a temperature in the range of from 50 to 1500 °C, more preferably in the range of from 100 to 1400 °C, more preferably in the range of from 400 to 1100 °C, more preferably in the range of from 600 to 900 °C.

It is preferred that the feedstock gas stream fed into the heated reactor according to (vii) has a pressure in the range of from 0.5 to 110 bar(abs), more preferably in the range of from 1 to 100 bar(abs), more preferably in the range of from 30 to 70 bar(abs), more preferably in the range of from 40 to 60 bar(abs).

It is preferred that the endothermic reaction is selected from the group consisting of a NH₃ reforming reaction, a steam cracking reaction, an alkane dehydrogenation reaction, more preferably an ethane dehydrogenation reaction, a propane dehydrogenation reaction, or a butane dehydrogenation reaction, a steam reforming reaction, a dry reforming reaction, a styrene production reaction, a methanol reforming reaction, a dimethyl ether reforming reaction, a reverse water-gas shift reaction, and an alcohol dehydration reaction.

In case where the endothermic reaction is a NH₃ reforming reaction, it is preferred that the NH₃ reforming reaction is performed in the presence of a catalytic material.

In case where the NH₃ reforming reaction is performed in the presence of a catalytic material, it is preferred that the catalytic material comprises a metal M1, wherein M1 is Ni, Co, or Ni and Co.

In case where the catalytic material comprises a metal M1, wherein M1 is Ni, Co, or Ni and Co, it is preferred that the catalytic material further comprises a metal M2 selected from the group consisting of alkali metals, alkaline earth metals, Mo, Fe, Ru, including mixtures of two or more thereof, more preferably from the group consisting of Li, K, Na, Cs, Mg, Ca, Sr, Ba, Mo, Fe, Ru, including mixtures of two or more thereof, more preferably from the group consisting of K, Na, Cs, Ba, Mo, Fe, Ru, including mixtures of two or more thereof, more preferably from the group consisting of K, Ba, Mo, Fe, Ru, and mixtures of two or more thereof, wherein M2 more preferably comprises Fe, Ru, or Fe and Ru, wherein more preferably M2 comprises Ru, wherein more preferably M2 is Ru.

Furthermore and independently thereof, it is preferred that the catalytic material further comprises one or more support materials onto which the metal M1 or the metals M1 and M2 are supported, wherein the one or more support materials are more preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and a mixture thereof, wherein more preferably the support material comprises Al₂O₃.

Furthermore and independently thereof, it is preferred that the catalytic material displays an M2:M1 atomic ratio in the range of from 0.1:99.9 to 80:20, more preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.

Furthermore, it is preferred that M2 comprises, more preferably is, Fe, and wherein the catalytic material displays an M2:M1 atomic ratio in the range of from 1:99 to 80:20, more preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.

Furthermore and independently thereof, it is preferred that M2 comprises, more preferably is, Ru, and wherein the catalytic material displays an M2:M1 atomic ratio in the range of from 0.1:99.9 to 30:70, preferably of from 0.5:99.5 to 30:70, more preferably of from 1:99 to 20:80,more preferably of from 3:97 to 10:90, and more preferably of from 5:95 to 6:94. Furthermore and independently thereof, it is preferred that the catalytic material further comprises Al and O.

In case where the catalytic material further comprises Al and O, it is preferred that the catalytic material comprises Ni as the metal M1, wherein more preferably the metal M1 is Ni.

In case where the catalytic material comprises Ni as the metal M1, it is preferred that the catalytic material further comprises Mg, wherein the Ni:Mg:Al molar ratio is in the range of from 1:(0.1-12):(0.5- 20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).

Furthermore and independently thereof, it is preferred that from 95 to 100 wt.-% of the catalytic material consists of Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that from 95 to 100 wt.-% of the catalytic material consists of M 2, Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

In case where the catalytic material further comprises Al and O, it is preferred that the catalytic material comprises Co as the metal M1, wherein more preferably the metal M1 is Co.

In case where the catalytic material comprises Co as the metal M1, it is preferred that the catalytic material further comprises La, wherein the Co:La:Al molar ratio is in the range of from 1:(0.1-8): (1-50), more preferably of from 1: (0.5-5): (3-30), more preferably of from 1:(0.8-3):(5-20), more preferably of from 1:(1-2):(8-15), and more preferably of from 1:(1.3-1.7):(10-12).

Furthermore and independently thereof, it is preferred that from 95 to 100 wt.-% of the catalytic material consists of Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that from 95 to 100 wt.-% of the catalytic material consists of M2, Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

According to the present invention, it is preferred that the endothermic reaction is selected from the group consisting of, a steam cracking reaction, an alkane dehydrogenation reaction, more preferably an ethane dehydrogenation reaction, a propane dehydrogenation reaction, or a butane dehydrogenation reaction, a steam reforming reaction, a dry reforming reaction, a styrene production reaction, a methanol reforming reaction, a dimethyl ether reforming reaction, a reverse water-gas shift reaction, and an alcohol dehydration reaction.

In case where the NH₃ reforming reaction is performed in the presence of a catalytic material, it is preferred that the catalytic material comprises Ru and one or more support materials, wherein Ru is supported on the one or more support materials, wherein the one or more support materials display a BET surface area of 20 m²/g or more, wherein the BET surface area is preferably determined according to ISO 9277:2010, and wherein the catalytic material contains 1 wt.-% or less of Ni and Co calculated as the respective element and based on 100 wt.-% of the catalytic material.

In case where the catalytic material comprises Ru and one or more support materials, it is preferred that the catalytic material contains 0.5 wt.-% or less of Ni and Co calculated as the respective element and based on 100 wt.-% of the catalytic material, more preferably 0.1 wt.-% or less, more preferably 0.05 wt.-% or less, more preferably 0.01 wt.-% or less, more preferably 0.005 wt.-% or less, and more preferably 0.001 wt.-% or less.

Furthermore, it is preferred that the catalytic material contains 1 wt.-% or less of Ni and Co calculated as the respective element and based on 100 wt.-% of the total contents of the reactor, more preferably 0.5 wt.-% or less, more preferably 0.1 wt.-% or less, more preferably 0.05 wt.-% or less, more preferably 0.01 wt.-% or less, more preferably 0.005 wt.-% or less, and more preferably 0.001 wt.-% or less.

Furthermore and independently thereof, it is preferred that the one or more support materials display a BET surface area in the range of from 30 to 800 m²/g, more preferably of from 40 to 500 m²/g, more preferably of from 50 to 300 m²/g, more preferably of from 60 to 200 m²/g, more preferably of from 70 to 100m²/g, and more preferably of from 75 to 80 m²/g.

Furthermore and independently thereof, it is preferred that the one or more support materials display a BET surface area in the range of from greater than 20 to 150 m²/g, more preferably of from 21 to 100 m²/g, more preferably of from 22 to 70 m²/g, more preferably of from 23 to 50 m²/g, more preferably of from 24 to 40 m²/g, and more preferably of from 25 to 35 m²/g.

Furthermore and independently thereof, it is preferred that the one or more support materials display a pore volume in the range of from 0.2 to 3 ml/g, more preferably of from 0.4 to 1.5 ml/g, more preferably of from 0.6 to 1 ml/g, and more preferably of from 0.8 to 0.85 ml/g, wherein the pore volume is preferably determined according to ISO 15901-2:2022.

Furthermore and independently thereof, it is preferred that the catalytic material displays a BET surface area in the range of 20 to 800 m²/g, more preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.

Furthermore and independently thereof, it is preferred that the catalytic material displays a pore volume in the range of 0.1 to 2 ml/g, more preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2: 2022.

Furthermore and independently thereof, it is preferred that from 90 to 100 wt.-% of Ru calculated as the element, and based on 100 wt.-% of Ru contained in the catalytic material, is supported on the one or more support materials comprised in the catalytic material, more preferably of from 95 to 100 wt.-%, more preferably of from 99 to 100 wt.-%, more preferably of from 99.5 to 100 wt.-%, and more preferably of from 99.9 to 100 wt.-%.

Furthermore and independently thereof, it is preferred that Ru is supported on the one or more support materials by an impregnation technique employing an aqueous solution of one or more ruthenium salts, wherein the one or more ruthenium salts more preferably comprise Ru(NO)(NO₃)₃, wherein more preferably Ru(NO)(NO₃)₃ is employed as the one or more ruthenium salts.

Furthermore and independently thereof, it is preferred that the one or more support materials are selected from the group consisting of metal oxides, wherein the metal of the metal oxides is more preferably selected from the group consisting of Al, Si, Ti, Zr, Hf, V, Nb, Ta, Cr, Mo, W, Mn, alkaline earth metals, and rare earth metals, including combinations of two or more thereof, AI, Si, Ti, Zr, Mg, Ca, La, Ce, Pr, and Nd, including combinations of two or more thereof, Al, Ti, Zr, Mg, Ca, and La, including combinations of two or more thereof, Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.

In case where the one or more support materials comprise ZrO₂, it is preferred that the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.

Furthermore and independently thereof, it is preferred that the one or more support materials contain substantially no CaO and/or MgO, more preferably substantially no CaO and MgO, more preferably substantially no alkaline earth metal oxide, more preferably substantially no Ca and/or Mg, more preferably substantially no Ca and Mg, and more preferably substantially no alkaline earth metal.

Furthermore and independently thereof, it is preferred that the one or more support materials contain substantially no Al₂O₃ and/or SiO₂, more preferably substantially no Al₂O₃ and SiO₂, more preferably substantially no Al and/or Si, and more preferably substantially no Al and Si.

Furthermore and independently thereof, it is preferred that the one or more support materials contain substantially no carbon nanotubes, more preferably substantially no elemental carbon, and more preferably substantially no carbon.

Furthermore and independently thereof, it is preferred that the catalytic material comprises Ru in an amount in the range of from 0.5 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

Furthermore and independently thereof, it is preferred that from 95 to 100 wt.-% of the catalytic material consists of Ru and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that the catalytic material further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are more preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalytic material further comprises KOH and/or LiOH, preferably KOH.

Furthermore and independently thereof, it is preferred that the catalytic material comprises the one or more alkali metal hydroxides in an amount in the range of from 0.5 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

Furthermore and independently thereof, it is preferred that from 95 to 100 wt.-% of the catalytic material consists of Ru, the one or more alkali metal hydroxides, and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Furthermore and independently thereof, it is preferred that the catalytic material is in the form of a molding and/or in powder form, more preferably in the form of a molding, and more preferably in the form of extrudates.

In case where the catalytic material is in the form of extrudates, it is preferred that the extrudates have a diameter in the range of from 0.5 to 10 mm, more preferably of from 1 to 7 mm, more preferably of from 1.5 to 5 mm, more preferably of from 2 to 4 mm, and more preferably of from 2.5 to 3.5 mm.

Furthermore and independently thereof, it is preferred that the extrudates are split, and the catalytic material is in the form of extrudates of a split sieve fraction in the range of from 50 μm to 2.5 mm, more preferably of from 100 μm to 1.5 mm, more preferably of from 200 μm to 1 mm, more preferably of from 250 to 700 μm, and more preferably of from 300 to 500 μm.

According to the present invention, it is preferred that the endothermic reaction is performed at a temperature in the range of from 200 to 1100 °C, more preferably in the range of from 400 to 900 °C, more preferably in the range of from 500 to 800 °C.

Furthermore, it is preferred that the endothermic reaction is performed at a pressure in the range of from 1 to 100 bar(abs), more preferably in the range of from 30 to 70 bar(abs), more preferably in the range of from 40 to 60 bar(abs).

Yet further it is preferred that the endothermic reaction is performed in the presence of a catalytic material or an inert material.

### Yet Further it Is Preferred That the Process Is a Continuous Process.

The present invention is further illustrated by the following set of embodiments and combinations of embodiments resulting from the dependencies and back-references as indicated. In particular, it is noted that in each instance where a range of embodiments is mentioned, for example in the context of a term such as “The composite oxide of any one of embodiments 1 to 4”, every embodiment in this range is meant to be explicitly disclosed for the skilled person, i.e. the wording of this term is to be understood by the skilled person as being synonymous to “The composite oxide of any one of embodiments 1, 2, 3, and 4”. Further, it is explicitly noted that the following set of embodiments is not the set of claims determining the extent of protection, but represents a suitably structured part of the description directed to general and preferred aspects of the present invention.
1. A process for performing an endothermic reaction in a reactor, the process comprising
   (i) providing a combustible stream comprising NH₃, wherein the stream is liquid or gaseous;
   (ii) heating the combustible stream provided in (i) to a temperature in the range of from 25 to 850 °C, for obtaining a heated combustible gas stream;
   (iii) optionally feeding the heated combustible gas stream obtained in (ii) into an ammonia reforming reactor for obtaining a gas stream comprising N₂ and H₂;
   (iv) feeding the heated combustible gas stream obtained in (ii) or the gas stream obtained in (iii) into a combustion chamber, wherein a reactor is contained in the combustion chamber;
   (v) combusting the combustible gas stream obtained in (ii) or the gas stream obtained in (iii) with oxygen in the combustion chamber, for heating the reactor contained in the combustion chamber to a temperature in the range of from 500 to 2100 °C, and for obtaining an exhaust gas stream exiting the combustion chamber;
   (vi) preparing a feedstock gas stream comprising one or more reactants for an endothermic reaction;
   (vii) feeding the feedstock gas stream into the heated reactor for performing the endothermic reaction;
   (viii) reacting the feedstock gas stream in the heated reactor for obtaining a product gas stream;
   wherein heating in (ii) comprises transferring heat of a reaction from a chemical conversion process to the combustible stream provided in (i), and
   wherein the exhaust gas stream obtained in (v) contains 5 volume-% or less of H₂.
2. The process of embodiment 1, wherein the combustible stream according to (i) has a temperature in the range of from 5 to 150 °C, preferably in the range of from 15 to 120 °C, more preferably in the range of from 20 to 105 °C, more preferably in the range of from 40 to 80 °C, more preferably in the range of from 50 to 70 °C.
3. The process of embodiment 1 or 2, wherein the combustible stream according to (i) has a pressure in the range of from 0.5 to 110 bar(abs), preferably in the range of from 1 to 100 bar(abs), more preferably in the range of from 30 to 70 bar(abs), more preferably in the range of from 40 to 60 bar(abs).
4. The process of any one of embodiments 1 to 3, wherein the combustible stream according to (i) comprises from 0 to 1 volume-% of O₂, preferably from 0 to 0.1 volume-%, more preferably from 0 to 0.01 volume-% of O₂.
5. The process of any one of embodiments 1 to 4, wherein the combustible stream according to (i) comprises from 98 to 100 volume-% of NH₃, preferably from 99 to 100 volume-%, more preferably from 99.9 to 100 volume-% of NH₃.
6. The process of any one of embodiments 1 to 5, wherein the combustible stream according to (i) comprises from 0 to 2.0 volume-% of H₂O, preferably from 0.01 to 1.5 volume-%, more preferably from 0.1 to 1.0 volume-% of H₂O.
7. The process of any one of embodiments 1 to 6, wherein from 90 to 100 volume-%, preferably from 95 to 100 volume-%, more preferably from 99 to 100 volume-%, of the combustible stream according to (i) consist of NH₃ and H₂O.
8. The process of any one of embodiments 1 to 7, wherein the combustible stream is heated according to (ii) to a temperature in the range of from 50 to 850 °C, preferably in the range of from 200 to 700 °C, more preferably in the range of from 300 to 600 °C, more preferably in the range of from 400 to 500 °C.
9. The process of any one of embodiments 1 to 8, wherein heating according to (ii) comprises transferring heat using a heat exchanger.
10. The process of any one of embodiments 1 to 9, wherein the heat which is transferred according to (ii) is provided by the exhaust gas stream exiting the combustion chamber according to (v) and/or from the product gas stream according to (viii).
11. The process of any one of embodiments 1 to 10, wherein the heat which is transferred according to (ii) is obtained from an exothermic reaction or wherein the heat which is transferred according to (ii) is excess heat of the heat employed for performing an autothermal reaction or an endothermic reaction.
12. The process of embodiment 11, wherein the exothermic reaction comprises, preferably consists of, one or more of methanol production, dimethyl ether production, NH₃ production, ethylene epoxidation, sulfuric acid production, and selective oxidation of one or more of alkanes, alkenes and alkynes, preferably selective oxidation of one or more of alkanes, alkenes and alkynes to acrolein or acrylic acid.
13. The process of embodiment 11, wherein the endothermic reaction comprises, preferably consists of, one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.
14. The process of embodiment 11, wherein the autothermal reaction comprises, preferably consists of, one or more of autothermal reforming of natural gas and hydrocarbons, and partial oxidation (POx) of hydrocarbons, wherein the hydrocarbons are selected from the group consisting of (C₁-C₁₀)alkanes, more preferably (C₁-C₈)alkanes, more preferably (C₁-C₇)alkanes.
15. The process of any one of embodiments 1 to 14, wherein in (iii) at least a portion of the NH₃ comprised in the heated combustible gas stream is converted in the ammonia reforming reactor to N₂ and H₂, wherein preferably from 0.1 to 99.9 volume-%, more preferably from 5 to 95 volume-% of NH₃ comprised in the heated combustible gas stream is converted in the ammonia reforming reactor to N₂ and H₂, based on 100 volume-% of NH₃ comprised in the heated combustible gas stream.
16. The process of any one of embodiments 1 to 15, wherein the ammonia reforming reactor according to (iii) comprises a catalytic material, preferably the catalytic material as defined in any one of embodiments 36to 74.
17. The process of any one of embodiments 1 to 16, wherein the reactor according to (iii) is an adiabatic reactor, an isothermal reactor, or a combination thereof.
18. The process of any one of embodiments 1 to 17, wherein the heated combustible gas stream fed into the reactor according to (iii) has a gas hourly space velocity in the range of from 50 to 30,000/h, preferably in the range of from 150 to 25,000/h, more preferably in the range of from 200 to 20,000/h, more preferably in the range of from 4,000 to 16,000/h, more preferably in the range of from 8,000 to 12,000/h.
19. The process of any one of embodiments 1 to 18, wherein the heated combustible gas stream fed into the reactor according to (iii) has a temperature in the range of from 100 to 1000 °C, preferably in the range of from 200 to 900 °C, more preferably in the range of from 400 to 700 °C, more preferably in the range of from 500 to 600 °C.
20. The process of any one of embodiments 1 to 19, wherein the heated combustible gas stream fed into the reactor according to (iii) has a pressure in the range of from 1 to 100 bar(abs), preferably in the range of from 10 to 35 bar(abs), more preferably in the range of from 14 to 31 bar(abs), more preferably in the range of from 18 to 27 bar(abs).
21. The process of any one of embodiments 1 to 20, wherein one or more co-fuels are fed into the combustion chamber together with the heated combustible gas stream obtained in (ii) or the gas stream obtained in (iii), wherein the one or more co-fuels are preferably selected from the group consisting of naphtha, hydrogen, gasoline, crude oil, pyrolysis oil, gasification products of biomass, (bio-)ethanol, alkanes, and mixtures of two or more thereof, wherein the one or more co-fuels more preferably comprise, more preferably consist of, (C₁-C₄)alkanes and mixtures thereof, more preferably (C₁-C₃)alkanes and mixtures thereof, more preferably (C₁-C₂)alkanes and mixtures thereof, wherein more preferably the one or more co-fuels more preferably comprise, more preferably consist of, CH₄.
22. The process of any one of embodiments 1 to 21, wherein the reactor comprises, preferably consists of, a reaction chamber or a tubular reactor, wherein the reactor preferably comprises, more preferably consists of, a tubular reactor, wherein the tubular reactor preferably comprises, more preferably consists of, 1 to 15,000 tubes, more preferably 100 to 11,000 tubes, and more preferably 500 to 5,000 tubes.
23. The process of embodiment 22, wherein independently from one another, the one or more tubes of the tubular reactor have a length in the range of from 1 to 30 m, more preferably in the range of from 9 to 21 m, and more preferably in the range of from 13 to 17 m.
24. The process of embodiment 22 or 23, wherein independently from one another, from 1 to 100 %, preferably from 30 to 70 %, more preferably from 40 to 60 %, of the length of the tubes of the tubular reactor passes through the combustion chamber.
25. The process of any one of embodiments 22 to 24, wherein independently from one another, the tubes of the tubular reactor have a diameter in the range of from 0.01 to 10 m, more preferably in the range of from 2 to 8 m, and more preferably in the range of from 4 to 6 m.
26. The process of any one of embodiments 1 to 25, wherein combusting the combustible gas stream according to (v) comprises
   (v.1) mixing the combustible gas stream with oxygen;
   (v.2) combusting the mixture obtained in (v.1) in the combustion chamber, for obtaining a gas stream having a temperature in the range of from 500 to 2100 °C.
27. The process of embodiment 26, wherein the volume ratio of oxygen to NH₃ comprised in the mixture obtained in (v. 1) is in the range of from 1:10 to 9:1, preferably in the range of from 1:5 to 1.8:1, and more preferably in the range of from 1:2 to 1.0:1.
28. The process of any one of embodiments 1 to 27, wherein the exhaust gas stream obtained in (v) contains from 0 to 4 volume-% of H₂, preferably from 0 to 3 volume-%, more preferably from 0 to 2 volume-%, more preferably from 0 to 1 volume-%, more preferably from 0 to 0.1 volume-%, more preferably from 0 to 0.01 volume-% of H₂.
29. The process of any one of embodiments 1 to 28, wherein the exhaust gas stream obtained in (v) has a temperature in the range of from 850 to 2100 °C, preferably in the range of from 950 to 1700 °C, more preferably in the range of from 1000 to 1400 °C.
30. The process of any one of embodiments 1 to 29, wherein the one or more reactants comprised in the feedstock gas stream according to (vi) are selected from the group consisting of naphtha, hydrogen, oxygen, gasoline, crude oil, pyrolysis oil, gasification products of biomass, (bio-)ethanol, methane, ethane, propane, butane, H₂O, CO₂, CO, NH₃, ethylbenzene, methanol, dimethyl ether, and mixtures of two or more thereof.
31. The process of any one of embodiments 1 to 30, wherein the feedstock gas stream fed into the heated reactor according to (vii) has a gas hourly space velocity in the range of from 50 to 300,000/h, preferably in the range of from 150 to 250,000/h, more preferably in the range of from 200 to 200,000/h, more preferably in the range of from 500 to 100,000/h, more preferably in the range of from 2,000 to 50,000/h.
32. The process of any one of embodiments 1 to 31, wherein the feedstock gas stream fed into the heated reactor according to (vii) has a temperature in the range of from 50 to 1500 °C, preferably in the range of from 100 to 1400 °C, more preferably in the range of from 400 to 1100 °C, more preferably in the range of from 600 to 900 °C.
33. The process of any one of embodiments 1 to 32, wherein the feedstock gas stream fed into the heated reactor according to (vii) has a pressure in the range of from 0.5 to 110 bar(abs), preferably in the range of from 1 to 100 bar(abs), more preferably in the range of from 30 to 70 bar(abs), more preferably in the range of from 40 to 60 bar(abs).
34. The process of any one of embodiments 1 to 33, wherein the endothermic reaction is selected from the group consisting of a NH₃ reforming reaction, a steam cracking reaction, an alkane dehydrogenation reaction, preferably an ethane dehydrogenation reaction, a propane dehydrogenation reaction, or a butane dehydrogenation reaction, a steam reforming reaction, a dry reforming reaction, a styrene production reaction, a methanol reforming reaction, a dimethyl ether reforming reaction, a reverse water-gas shift reaction, and an alcohol dehydration reaction.
35. The process of embodiment 34, wherein the endothermic reaction is a NH₃ reforming reaction, wherein the NH₃ reforming reaction is preferably performed in the presence of a catalytic material.
36. The process of embodiment 35, wherein the catalytic material comprises a metal M1,wherein M1 is Ni, Co, or Ni and Co.
37. The process of embodiment 36, wherein the catalytic material further comprises a metal M2 selected from the group consisting of alkali metals, alkaline earth metals, Mo, Fe, Ru, including mixtures of two or more thereof, preferably from the group consisting of Li, K, Na, Cs, Mg, Ca, Sr, Ba, Mo, Fe, Ru, including mixtures of two or more thereof, more preferably from the group consisting of K, Na, Cs, Ba, Mo, Fe, Ru, including mixtures of two or more thereof, more preferably from the group consisting of K, Ba, Mo, Fe, Ru, and mixtures of two or more thereof, wherein M2 more preferably comprises Fe, Ru, or Fe and Ru, wherein more preferably M2 comprises Ru, wherein more preferably M2 is Ru.
38. The process of embodiment 36 or 37, wherein the catalytic material further comprises one or more support materials onto which the metal M1 or the metals M1 and M2 are supported, wherein the one or more support materials are preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and a mixture thereof, wherein more preferably the support material comprises Al₂O₃.
39. The process of any one of embodiments 36 to 38, wherein the catalytic material displays an M2:M1 atomic ratio in the range of from 0.1:99.9 to 80:20, preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.
40. The process of embodiment 39, wherein M2 comprises, preferably is, Fe, and wherein the catalytic material displays an M2:M1 atomic ratio in the range of from 1:99 to 80:20, preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.
41. The process of embodiment 39 or 40, wherein M2 comprises, preferably is, Ru, and wherein the catalytic material displays an M2:M1 atomic ratio in the range of from 0.1:99.9 to 30:70, preferably of from 0.5:99.5 to 30:70, more preferably of from 1:99 to 20:80, more preferably of from 3:97 to 10:90, and more preferably of from 5:95 to 6:94.
42. The process of any one of embodiments 39 to 41, wherein the catalytic material further comprises Al and O.
43. The process of embodiment 42, wherein the catalytic material comprises Ni as the metal M1, wherein preferably the metal M1 is Ni.
44. The process of embodiment 43, wherein the catalytic material further comprises Mg, wherein the Ni:Mg:Al molar ratio is preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).
45. The process of embodiment 43 or 44, wherein from 95 to 100 wt.-% of the catalytic material consists of Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
46. The process of embodiment 43 or 44, wherein from 95 to 100 wt.-% of the catalytic material consists of M2, Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
47. The process of embodiment 42, wherein the catalytic material comprises Co as the metal M1, wherein preferably the metal M1 is Co.
48. The process of embodiment 47, wherein the catalytic material further comprises La, wherein the Co:La:Al molar ratio is preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).
49. The process of embodiment 47 or 48, wherein from 95 to 100 wt.-% of the catalytic material consists of Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
50. The process of embodiment 47 or 48, wherein from 95 to 100 wt.-% of the catalytic material consists of M2, Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
51. The process of any one of embodiments 1 to 50, wherein the endothermic reaction is selected from the group consisting of, a steam cracking reaction, an alkane dehydrogenation reaction, preferably an ethane dehydrogenation reaction, a propane dehydrogenation reaction, or a butane dehydrogenation reaction, a steam reforming reaction, a dry reforming reaction, a styrene production reaction, a methanol reforming reaction, a dimethyl ether reforming reaction, a reverse water-gas shift reaction, and an alcohol dehydration reaction.
52. The process of embodiment 35, wherein the catalytic material comprises Ru and one or more support materials, wherein Ru is supported on the one or more support materials, wherein the one or more support materials display a BET surface area of 20 m²/g or more, wherein the BET surface area is preferably determined according to ISO 9277:2010, and wherein the catalytic material contains 1 wt.-% or less of Ni and Co calculated as the respective element and based on 100 wt.-% of the catalytic material.
53. The process of embodiment 52, wherein the catalytic material contains 0.5 wt.-% or less of Ni and Co calculated as the respective element and based on 100 wt.-% of the catalytic material, preferably 0.1 wt.-% or less, more preferably 0.05 wt.-% or less, more preferably 0.01 wt.-% or less, more preferably 0.005 wt.-% or less, and more preferably 0.001 wt.-% or less.
54. The process of embodiment 52 or 53, wherein the catalytic material contains 1 wt.-% or less of Ni and Co calculated as the respective element and based on 100 wt.-% of the total contents of the reactor, preferably 0.5 wt.-% or less, more preferably 0.1 wt.-% or less, more preferably 0.05 wt.-% or less, more preferably 0.01 wt.-% or less, more preferably 0.005 wt.-% or less, and more preferably 0.001 wt.-% or less.
55. The process of any one of embodiments 52 to 54, wherein the one or more support materials display a BET surface area in the range of from 30 to 800 m²/g, preferably of from 40 to 500 m²/g, more preferably of from 50 to 300 m²/g, more preferably of from 60 to 200 m²/g, more preferably of from 70 to 100 m²/g, and more preferably of from 75 to 80 m²/g.
56. The process of any one of embodiments 52 to 55, wherein the one or more support materials display a BET surface area in the range of from greater than 20 to 150 m²/g, preferably of from 21 to 100 m²/g, more preferably of from 22 to 70 m²/g, more preferably of from 23 to 50 m²/g, more preferably of from 24 to 40 m²/g, and more preferably of from 25 to 35 m²/g.
57. The process of any one of embodiments 52 to 56, wherein the one or more support materials display a pore volume in the range of from 0.2 to 3 ml/g, preferably of from 0.4 to 1.5 ml/g, more preferably of from 0.6 to 1 ml/g, and more preferably of from 0.8 to 0.85 ml/g, wherein the pore volume is preferably determined according to ISO 15901-2: 2022.
58. The process of any one of embodiments 52 to 57, wherein the catalytic material displays a BET surface area in the range of 20 to 800 m²/g, preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.
59. The process of any one of embodiments 52 to 58, wherein the catalytic material displays a pore volume in the range of 0.1 to 2 ml/g, preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2: 2022.
60. The process of any one of embodiments 52 to 59, wherein from 90 to 100 wt.-% of Ru calculated as the element, and based on 100 wt.-% of Ru contained in the catalytic material, is supported on the one or more support materials comprised in the catalytic material, preferably of from 95 to 100 wt.-%, more preferably of from 99 to 100 wt.-%, more preferably of from 99.5 to 100 wt.-%, and more preferably of from 99.9 to 100 wt.-%.
61. The process of any one of embodiments 52 to 60, wherein Ru is supported on the one or more support materials by an impregnation technique employing an aqueous solution of one or more ruthenium salts, wherein the one or more ruthenium salts preferably comprise Ru(NO)(NO₃)₃, wherein more preferably Ru(NO)(NO₃)₃ is employed as the one or more ruthenium salts.
62. The process of any one of embodiments 52 to 61, wherein the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, Al, Si, Ti, Zr, Mg, Ca, La, Ce, Pr, and Nd, including combinations of two or more thereof, Al, Ti, Zr, Mg, Ca, and La, including combinations of two or more thereof, Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.
63. The process of embodiment 62, wherein the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.
64. The process of any one of embodiments 52 to 63, wherein the one or more support materials contain substantially no CaO and/or MgO, preferably substantially no CaO and MgO, more preferably substantially no alkaline earth metal oxide, more preferably substantially no Ca and/or Mg, more preferably substantially no Ca and Mg, and more preferably substantially no alkaline earth metal.
65. The process of any one of embodiments 52 to 64, wherein the one or more support materials contain substantially no Al₂O₃ and/or SiO₂, preferably substantially no Al₂O₃ and SiO₂, more preferably substantially no Al and/or Si, and more preferably substantially no Al and Si.
66. The process of any one of embodiments 52 to 65, wherein the one or more support materials contain substantially no carbon nanotubes, preferably substantially no elemental carbon, and more preferably substantially no carbon.
67. The process of any one of embodiments 52 to 66, wherein the catalytic material comprises Ru in an amount in the range of from 0.5 to 15 wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
68. The process of any one of embodiments 52 to 67, wherein from 95 to 100 wt.-% of the catalytic material consists of Ru and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
69. The process of any one of embodiments 52 to 68, wherein the catalytic material further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalytic material further comprises KOH and/or LiOH, preferably KOH.
70. The process of any one of embodiments 52 to 69, wherein the catalytic material comprises the one or more alkali metal hydroxides in an amount in the range of from 0.5 to 15wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
71. The process of any one of embodiments 52 to 70, wherein from 95 to 100 wt.-% of the catalytic material consists of Ru, the one or more alkali metal hydroxides, and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
72. The process of any one of embodiments 52 to 71, wherein the catalytic material is in the form of a molding and/or in powder form, preferably in the form of a molding, and more preferably in the form of extrudates.
73. The process of embodiment 72, wherein the extrudates have a diameter in the range of from 0.5 to 10 mm, preferably of from 1 to 7 mm, more preferably of from 1.5 to 5 mm, more preferably of from 2 to 4 mm, and more preferably of from 2.5 to 3.5 mm.
74. The process of embodiment 72 or 73, wherein the extrudates are split, and the catalytic material is in the form of extrudates of a split sieve fraction in the range of from 50 μm to 2.5 mm, preferably of from 100 μm to 1.5 mm, more preferably of from 200 μm to 1 mm, more preferably of from 250 to 700 μm, and more preferably of from 300 to 500 μm.
75. The process of any one of embodiments 1 to 74 wherein the endothermic reaction is performed at a temperature in the range of from 200 to 1100 °C, preferably in the range of from 400 to 900 °C, more preferably in the range of from 500 to 800 °C.
76. The process of any one of embodiments 1 to 75, wherein the endothermic reaction is performed at a pressure in the range of from 1 to 100 bar(abs), preferably in the range of from 30 to 70 bar(abs), more preferably in the range of from 40 to 60 bar(abs).
77. The process of any one of embodiments 1 to 76, wherein the endothermic reaction is performed in the presence of a catalytic material or an inert material.
78. The process of any one of embodiments 1 to 77, wherein the process is a continuous process.

The present invention is further illustrated by the following examples and comparative examples.

### EXPERIMENTAL SECTION

### Example 1: Process for Performing an Endothermic Reaction in a Reactor

A combustion chamber is provided as depicted in FIG. 1, which can be heated by combusting a combustible stream therein with oxygen. The combustible stream comprises NH₃, part of which can be reformed prior to combustion in the combustion chamber. The combustible stream can additionally comprise a co-fuel. The combustible stream comprising NH₃ can be seen as a blend of a conventional fuel with NH₃, having an energy content of 7-8 MW.

Prior to combustion, the combustible stream is heated by transferring heat of a reaction from a chemical conversion process. The heat can be obtained from an exothermic reaction or it can be the excess heat of the heat employed for performing an autothermal reaction or an endothermic reaction. For example, water and/or steam can be used for transferring heat from the chemical conversion process to the combustible stream.

Further, as depicted in FIG. 1, a tubular reactor passes through the combustion chamber. In the reactor, an endothermic reaction takes place. The endothermic reaction can, for example, be a steam cracking process.

### BRIEF DESCRIPTION OF FIGURES

FIG. 1: schematically shows a combustion chamber containing a tubular reactor according to Example 1, wherein the reactor passes through the combustion chamber.

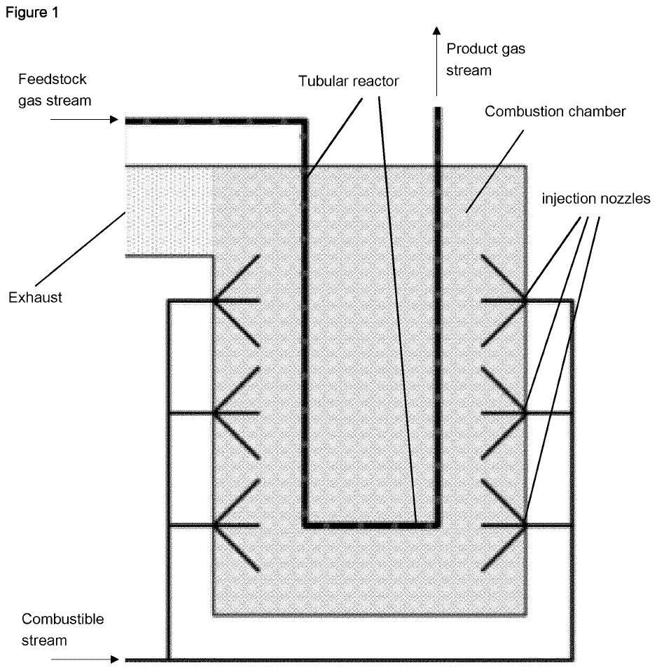

### CITED LITERATURE

Banares-Alcantara et al. in Applied Energy 2021, 282, 116009
U.S. Pat. No. 8,464,515 B2
WO 2019/038251 A1
U.S. Pat. No. 8,691,182 B2
U.S. Pat. No. 8,961,923 B2

1.-15. (canceled)

16. A process for performing an endothermic reaction in a reactor, the process comprising
(i) providing a combustible stream comprising NH₃, wherein the stream is liquid or gaseous;
(ii) heating the combustible stream provided in (i) to a temperature in the range of from 25 to 850 °C, for obtaining a heated combustible gas stream;
(iii) optionally feeding the heated combustible gas stream obtained in (ii) into an ammonia reforming reactor for obtaining a gas stream comprising N₂ and H₂;
(iv) feeding the heated combustible gas stream obtained in (ii) or the gas stream obtained in (iii) into a combustion chamber, wherein a reactor is contained in the combustion chamber;
(v) combusting the combustible gas stream obtained in (ii) or the gas stream obtained in (iii) with oxygen in the combustion chamber, for heating the reactor contained in the combustion chamber to a temperature in the range of from 500 to 2100 °C, and for obtaining an exhaust gas stream exiting the combustion chamber;
(vi) preparing a feedstock gas stream comprising one or more reactants for an endothermic reaction;
(vii) feeding the feedstock gas stream into the heated reactor for performing the endothermic reaction;
(viii) reacting the feedstock gas stream in the heated reactor for obtaining a product gas stream;
wherein heating in (ii) comprises transferring heat of a reaction from a chemical conversion process to the combustible stream provided in (i), and
wherein the exhaust gas stream obtained in (v) contains 5 volume-% or less of H₂.

17. The process of claim 16, wherein the combustible stream according to (i) comprises from 0 to 1 volume-% of O₂.

18. The process of claim 16, wherein the combustible stream according to (i) comprises from 98 to 100 volume-% of NH₃.

19. The process of claim 16, wherein the combustible stream according to (i) comprises from 0 to 2.0 volume-% of H₂O.

20. The process of claim 16, wherein heating according to (ii) comprises transferring heat using a heat exchanger.

21. The process of claim 16, wherein the heat which is transferred according to (ii) is provided by the exhaust gas stream exiting the combustion chamber according to (v) and/or from the product gas stream according to (viii).

22. The process of claim 16, wherein the heat which is transferred according to (ii) is obtained from an exothermic reaction or wherein the heat which is transferred according to (ii) is excess heat of the heat employed for performing an autothermal reaction or an endothermic reaction.

23. The process of claim 16, wherein the reactor according to (iii) is an adiabatic reactor, an isothermal reactor, or a combination thereof.

24. The process of claim 16, wherein combusting the combustible gas stream according to
(v) comprises
(v.1) mixing the combustible gas stream with oxygen;
(v.2) combusting the mixture obtained in (v.1) in the combustion chamber, for obtaining a gas stream having a temperature in the range of from 500 to 2100 °C

25. The process of claim 16, wherein the endothermic reaction is a NH₃ reforming reaction, wherein the NH₃ reforming reaction is performed in the presence of a catalytic material.

26. The process of claim 25, wherein the catalytic material comprises a metal M1, wherein M1 is Ni, Co, or Ni and Co.

27. The process of claim 25, wherein the catalytic material comprises Ru and one or more support materials, wherein Ru is supported on the one or more support materials, wherein the one or more support materials display a BET surface area of 20 m²/g or more, and wherein the catalytic material contains 1 wt.-% or less of Ni and Co calculated as the respective element and based on 100 wt.-% of the catalytic material.

28. The process of claim 27, wherein the catalytic material further comprises one or more alkali metal and/or alkaline earth metal hydroxides, wherein the one or more alkali metal and/or alkaline earth metal hydroxides are supported on the one or more support materials supporting Ru.

29. The process of claim 16, wherein the endothermic reaction is performed at a temperature in the range of from 200 to 1100 °C.

30. The process of claim 16, wherein the endothermic reaction is performed in the presence of a catalytic material or an inert material.
